(19) United States
(12) Patent Application Publication
(10) Pub. No.: US 2007/0146305 A1
(43) Pub. Date: Jun. 28, 2007

(54) Testing system for liquid crystal display

(75) Inventors: Ming-Lei Niu, Shenzhen (CN); Yan-Bo Yu, Shenzhen (CN); Kuang-Liang Huang, Miao-Li (TW); Liang-Yan Dai, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/642,097

(22) Filed: Dec. 20, 2006

(30) Foreign Application Priority Data
Dec. 23, 2005 (TW) 94146333

(51) Int. Cl. G09G 3/36

(52) U.S. Cl. 345/104

(57) ABSTRACT

An exemplary testing system for liquid crystal displays includes a host (1) and a liquid crystal display (2). The host includes a display card (10) having a memory (105). Plural reference data according to a plurality of timing control modes are stored in the memory. The display card controls the liquid crystal display to display testing images by transmitting horizontal synchronization signals, vertical synchronization signals, red signals, green signals, and blue signals to the liquid crystal display using one of the timing control modes.

### FIELD OF THE INVENTION

The present invention relates to a system for testing liquid crystal displays (LCDs), and particularly to a testing system capable of modifying timing control mode of a display card employed in the testing system.

### BACKGROUND

Generally, an LCD has a complicated structure, and a great deal of equipment is required for testing of the LCD by designers and quality controllers. A conventional method for testing of an LCD is: firstly, generating display signals, inputting the display signals to the LCD being tested, and displaying images on the LCD according to the display signals; and secondly, testing the performance of the LCD using the images displayed on the LCD.

Referring to FIG. 3, a timing chart of signals generated by hardware used in testing an LCD is shown. The hardware transmits signals to the LCD being tested, the signals including a horizontal synchronization (H-Sync) signal and a vertical synchronization (V-Sync) signal, and red signals, green signals, and blue signals (RGB signals). The H-Sync signal and the V-Sync signal are transmitted to the LCD during the time period T1˜T2, and then the RGB signals are transmitted to circuits of the LCD allowing the LCD to display corresponding images during the time period T3˜T4. According to this mode, the H-Sync signal and the V-Sync signal are transmitted to the LCD during the time period T5˜T6, and then the RGB signals are transmitted to circuits of the LCD again to allow the LCD to display images during the time period T7˜T8.

The images to be displayed on the LCD correspond to those supplied. by the RGB signals, and the LCD displays different images according to different RGB signals. The RGB signals are directed to the corresponding pixels of the LCD by the H-Sync signal and the V-Sync signal in a timing control mode. The RGB signals, the H-Sync signal, and the V-Sync signal are generated by a signal generating device, such as, for example, a pattern generator.

The pattern generator has a signal timing control mode. The H-Sync signal and the V-Sync signal generated by the pattern generator can only convert the RGB signals into display images in a single timing control mode. When the LCDs being tested are of different size, the timing control mode of the pattern generator cannot be adjusted. Therefore, different pattern generators are required for testing LCDs of different sizes. This makes the testing process unduly complicated and inefficient. In addition, each pattern generator is an expensive piece of equipment.

Accordingly, what is needed is a testing system for LCDs that can overcome the above-described deficiencies.

### SUMMARY

An exemplary testing system for liquid crystal displays includes a host computer and an LCD. The host computer includes a display card having a memory, and a plurality of reference data including a plurality of timing control modes stored in the memory. The display card controls the liquid crystal display to display test images by transmitting horizontal synchronization signals, vertical synchronization signals, red signals, green signals, and blue signals to the liquid crystal display using one of the timing control modes.

Other advantages and novel features will become more apparent from the following detailed description of preferred embodiments when taken in conjunction with the accompanying drawings.

### BRIEF DESCRIPTION OF THE DRAWINGS

FIG. 1 is a block diagram of a testing system for LCDs according to an exemplary embodiment of the present invention.

FIG. 2 is a timing chart of signals generated by a display card employed in the testing system of FIG. 1.

FIG. 3 is a timing chart of signals generated by conventional hardware and used in testing an LCD.

### DETAILED DESCRIPTION OF PREFERRED EMBODIMENTS

Reference will now be made to the drawings to describe the preferred embodiments in detail.

Referring to FIG. 1, a block diagram of a testing system for LCDs is shown. The testing system 100 includes a host 1 and an LCD 2. In illustrated embodiment, the host 1 is a personal computer, which includes a VGA (video graphics array) display card 10 having a memory 105. The memory 105 can, for example, be a register.

Reference data according to a plurality of timing control modes for controlling the LCD 2 to display testing images is stored in the memory 105. The display card 10 controls the LCD 2 to display test images by transmitting a horizontal synchronization signal, a vertical synchronization signal, a red signal, a green signal, and a blue signal to the LCD using one of the timing control modes.

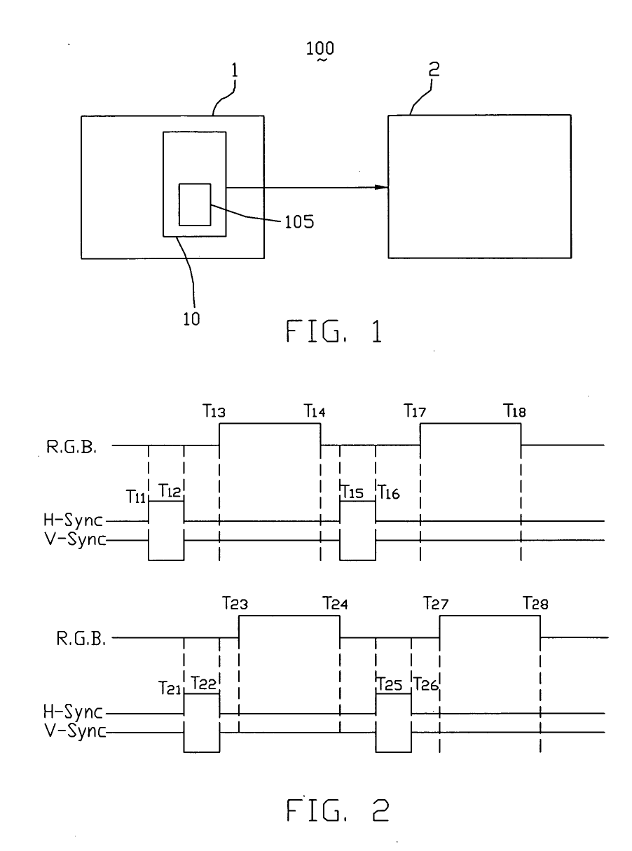

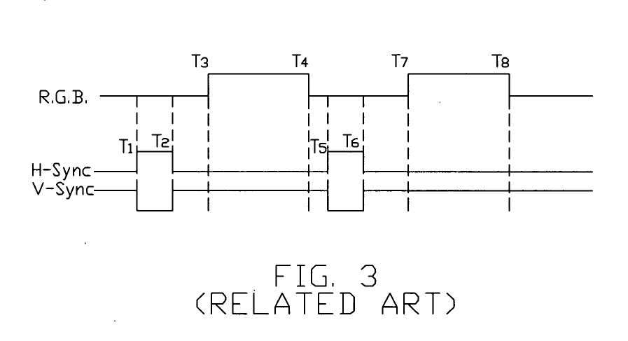

Also referring to FIG. 2, a timing chart of signals generated by the display card 10 is shown. When the LCD 2 being tested is tested according to a first timing control mode, the first time period T11˜T12 is equal to the third time period T15˜T16, the second time period T13˜T14 is equal to the fourth time period T17˜T18, and the interval between the point in time T12 and the point in time T13 is equal to that between the point in time T16 and the point in time T17. The software in the host 1 drives the display card 10 to transmit a horizontal synchronization (H-Sync) signal and a vertical synchronization (V-Sync) signal, and red signals, green signals, and blue signals (RGB signals) to the LCD 2 in succession. In particular, the H-Sync signal and the V-Sync signal are transmitted to the LCD 2 during the first time period T11˜T12, and then the RGB signals are transmitted to circuits of the LCD 2 causing the LCD 2 to display corresponding images during the second time period T13˜T14. According to this mode, the H-Sync signal and the V-Sync signal are transmitted to the LCD 2 during the third time period T15˜T16, and then the RGB signals are transmitted to circuits of the LCD 2 again causing the LCD 2 to display corresponding images during the fourth time period T17˜T18.

When the LCD 2 being tested has a different size corresponding to a second timing control mode, the software in the host 1 drives the display card 10 to transmit a horizontal synchronization (H-Sync) signal and a vertical synchronization (V-Sync) signal, and a red signal, a green signal, and a blue signal (RGB signals) to the LCD 2 according to a second timing control mode. In particular, the H-Sync signal and the V-Sync signal are transmitted to the LCD 2 during the fifth time period T21˜T22, and then the RGB signals are transmitted to circuits of the LCD 2 to cause the LCD 2 to display corresponding images during the sixth time period T23˜T24. In this mode, the H-Sync signal and the V-Sync signal are transmitted to the LCD 2 during the seventh time period T15˜T16, and then the RGB signals are transmitted to circuits of the LCD 2 again causing the LCD 2 to display corresponding images during the eighth time period T17˜T18. In the second timing control mode, the fifth time period T21˜T22 is equal to the seventh time period T25˜T26, which is also equal to the first and third time periods T11˜T12 and T15˜T16, respectively. The points in time T21 and T25 are delayed relative to the points in time T11 and T15, respectively. The sixth time period T23˜T24 is equal to the eighth time period T27˜T28, both of which are also equal to the second and fourth time periods T13˜T14 and T17˜T18, respectively. The points in time T23 and T27 are delayed relative to the points in time T13 and T17, respectively. The interval between the points in time T22 and T23 is equal to that between the points in time T26 and T27, and is less than the interval between the points in time T16 and T17.

For similar operational processes, the software in the host 1 may modify the timing control mode of the display card 10 according to the LCD 2 being tested.

In summary, the plurality of reference data according to a plurality of timing control modes for controlling the LCD 2 to display test images is stored in the memory 105 of the display card 10. The reference data form the basis for transmitting signals to the LCD 2 to display test images using one of the timing control modes. Additional hardware, such as a pattern generator, is thus not needed.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A testing system for a liquid crystal display, comprising:
a host comprising a display card having a memory;
wherein a plurality of reference data according to a plurality of timing control modes is stored in the memory, and the display card is configured for controlling the liquid crystal display to display testing images by transmitting horizontal synchronization signals, vertical synchronization signals, red signals, green signals, and blue signals to the liquid crystal display according to a selected one of the timing control modes.

2. The testing system as claimed in claim 1, wherein the display card is a video graphics array display card.

3. The testing system as claimed in claim 1, wherein when the size of the liquid crystal display to be tested is changed, software in the host modifies the display card and causes the display card to transmit a horizontal synchronization (H-Sync) signal, a vertical synchronization (V-Sync) signal, and red signals, green signals, blue signals (RGB signals) to the liquid crystal display according to another timing control mode.

4. The testing system as claimed in claim 3, wherein the time point to transmit the signals to the liquid crystal display is different for different timing control modes.

5. A method of testing a liquid crystal display, comprising:
providing a host comprising a display card having a memory;
wherein a plurality of reference data according to a plurality of timing control modes is stored in the memory, and the display card is configured for controlling the liquid crystal display to display testing images by transmitting horizontal synchronization signals, vertical synchronization signals, red signals, green signals, and blue signals to the liquid crystal display according to a selected one of the timing control modes.
